(19) United States
(12) Patent Application Publication
(10) Pub. No.: US 2018/0228124 A1
(43) Pub. Date: Aug. 16, 2018

(54) ANIMAL LITTER COMPRISING CINNAMIC AND/OR ROSMARINIC COMPOUNDS

(71) Applicant: The Clorox Company, Oakland, CA (US)

(72) Inventor: Elizabeth L. Donald, Pleasanton, CA (US)

(21) Appl. No.: 15/434,912

(22) Filed: Feb. 16, 2017

(51) Int. Cl. A01K 1/015

(52) U.S. Cl. CPC A01K 1/0154; A01K 1/0155

(57) ABSTRACT

The present invention is directed to litter compositions including a litter substrate and at least one cinnamic or rosmarinic compound disposed on or within the litter substrate which inhibits odor formation. Examples of cinnamic and/or rosmarinic compounds that have been shown to inhibit odor formation include trans-cinnamic acid, cinnamaldehyde, p-coumaric acid, sinapic acid, caffeic acid, hydrocinnamic acid, rosmarinic acid, ursolic acid, carnosic acid, and ferulic acid. The compositions may be free of ethyl cinnamate, and may include a borate, or be free of borates.

### BACKGROUND OF THE INVENTION

### 1. The Field of the Invention

The present invention relates to litter for use by domestic animals. For example, such litter is typically employed by pet owners to absorb urine and collect feces.

### 2. Background and Relevant Art

Many people enjoy the company of one or more domestic pets. Litter boxes are typically provided for the use of such animals in the collection of urine and feces. Such a litter box is typically filled with an absorbent granular material (e.g., sand and/or clay), which aids in collecting the bodily wastes produced by pets. Such litter materials often include a fragrance component (e.g., a fragrance oil) to mask the odor associated with such waste. Alternatively or additionally, some litters include a borate, which has been shown to aid in inhibiting odor formation.

Several difficulties exist with presently available litter compositions. The inclusion of fragrance oils do not aid in actually inhibiting odor formation, but rather simply help to mask the odor that is already present. In addition, while the inclusion of fragrance oils can be somewhat effective in masking odor, the fragrance often is lost or otherwise loses potency during storage, and particularly once initially wetted by the animal using the litter. As a result, fragrance oils often are not particularly effective even at masking odor where the litter may have been stored for a significant period of time prior to use, or if the litter is not replaced after initial wetting. For example, many consumers may change litter only every several days, or even less frequently.

Furthermore, some jurisdictions, e.g., many European countries, prohibit or severely restrict the use of borates in consumer products, such as litter. As such, there continues to be a need for improved litter products that could address problems associated with odor formation.

### BRIEF SUMMARY

The present invention is directed to litter compositions comprising a litter substrate (e.g., in the form of granules) and at least one cinnamic or rosmarinic compound disposed on or within the litter substrate, which compounds have now been discovered by the inventor to inhibit odor formation within the litter. For example, such compounds are typically not fragrance oils or essential oils, as the contemplated cinnamic and/or rosmarinic compounds often have little or no discernable scent or odor. Thus, such compounds are typically incapable of masking any malodor, as many of them have no significant scent or odor of their own. Rather, these specific compounds have been discovered to actually inhibit ammonia and/or other odor formation when included on or within a litter substrate.

Such compounds differ from mere inclusion of a cinnamon or rosemary essential oil in litter in that such essential oils are by definition scented. Similarly, the present litter compositions differ from mere inclusion of cinnamon or rosemary spice in litter, as it is important to ensure that only those cinnamic and/or rosemarinc compounds that inhibit odor formation are present, while specifically excluding other compounds which have actually been found to promote odor formation. For example, ethyl cinnamate is excluded from at least some embodiments of the present litter compositions. While this compound is found within cinnamon spice, and would also typically be present within a cinnamon essential oil, it is undesirable in the context of a litter composition, as it has specifically been found to actually promote, rather than inhibit odor formation.

Further differentiation of the present litter compositions is found in that essential oils are not typically a composition having a tightly controlled compositional profile, as essential oil composition may vary from plant source to plant source, from growing region to growing region, and from year (or season) to year (or season). Furthermore, a “first press” of an essential oil may include numerous components from the plant, while subsequent pressings or refining/purification steps may remove many of the components that may be present within such a “first press” of such an oil so that the commercially available essential oil composition may vary enormously in constituent components and concentrations of each, from one essential oil product to another essential oil product, from year to year, and region to region. Many, if not all of the contemplated cinnamic and/or rosmarinic compounds employed herein will actually thus not be present to any appreciable degree within a cinnamon essential oil, or a rosemary essential oil. Further, such essential oils, particularly cinnamon essential oil would include ethyl cinnamate, which actually promotes odor formation.

As noted above, the present inventor has found that only some cinnamic and/or rosmarinic compounds are actually capable of inhibiting odor formation, while other cinnamic and/or rosmarinic compounds, including those responsible for a characteristic scent, may actually work in an opposite manner, exacerbating odor formation. Ethyl cinnamate is an example of such a cinnamic compound that is a chief component of the typical classic cinnamon scent and taste, and which has now been shown by the present inventor to actually cause an increase in ammonia production when provided on or within a litter substrate.

Thus, the present invention is not merely the providing of a cinnamon or rosemary essential oil (or even a cinnamon or rosemary spice) on or within a litter substrate. Such would not reliably include those specific compounds that are desirable, and would undesirably include specific compounds that should actually be excluded from the composition. Such control over compound identity is necessary to ensure that cinnamic and/or rosmarinic compounds that would exacerbate odor formation are specifically excluded from the one or more cinnamic or rosmarinic compounds that are disposed on or within the litter substrate.

In other words, and by way of specific example, ethyl cinnamate is present in cinnamon essential oil, and cinnamon spice, and this compound has now been shown to actually exacerbate the odor formation problem. It is thus important to carefully control which compound or compounds are present, and to ensure that those that would exacerbate the odor formation problem are specifically excluded. Examples of suitable cinnamic and rosmarinic compounds that have been shown to inhibit odor formation (and thus one or more of them are included in the present litter compositions) include trans-cinnamic acid, cinnamaldehyde, p-coumaric acid, sinapic acid, caffeic acid, hydrocinnamic acid, rosmarinic acid, ursolic acid, carnosic acid, and ferulic acid, Combinations of one or more of the foregoing may also be employed, although in an embodiment, only a single cinnamic and/or rosmarinic compound is included, as the inventor has also discovered antagonistic interaction where some specific combinations are included. The litter compositions may be free, or at least substantially free, of ethyl cinnamate. Other compounds that may be present within cinnamon or rosemary, (or essential oils derived therefrom) that would exacerbate odor formation may also be specifically excluded.

The cinnamic and/or rosmarinic compound(s) may be admixed into a liquid composition (e.g., solution, suspension, and/or emulsion), and may be sprayed or otherwise applied to the litter substrate. In some embodiments, the cinnamic and/or rosmarinic compound(s) may be added to the litter substrate, e.g., which may then be mixed in a mixer, agglomerator or other suitable apparatus for making suitably sized litter granules or other litter particles.

In an embodiment, the litter composition may include a litter substrate comprising a bentonite clay (e.g., sodium bentonite and/or calcium bentonite), and at least one of the above identified cinnamic or rosmarinic compounds disposed on or within the litter substrate. While a borate may be present in some embodiments, in other embodiments, borates may specifically be excluded, such that the litter composition is free, or substantially free, of borates. As described above, the litter composition may be free or substantially free of ethyl cinnamate. Exclusion of borates is advantageous so as to meet some regulatory standards, but also, borates have been shown to be antagonistic relative to the odor inhibiting properties of some of the described cinnamic and/or rosmarinic compounds. As will be shown in the Examples section herein, in some instances, the combination of a borate with specific cinnamic and/or rosmarinic compounds surprisingly provides worse odor inhibition than is provided with virgin substrate alone (i.e., no borate, and no cinnamic/rosmarinic compound), whereas either the borate or the cinnamic and/or rosmarinic compound alone provides substantial inhibition of odor formation.

Additional features and advantages of exemplary implementations of the present invention will be set forth in the description which follows, and in part will be evident from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a graph showing mean ammonia production as a function of time for several different raw spices, and a litter substrate with no spice;

FIG. 2 is a graph showing mean ammonia production as a function of time for litter including one of several different specific cinnamic and/or rosmarinic compounds, for litter including a borate, and for litter substrate with no treatment;

FIG. 3 is a graph showing mean ammonia production as a function of time for litter including one of several different specific cinnamic and/or rosmarinic compounds, for litter alone, and for litter treated with other odor inhibiting agents; and

FIG. 4 is a graph showing mean ammonia production as a function of time for litter including rosmarinic acid, for litter including a combination of rosmarinic acid and caffeic acid, for litter including rosmarinic acid and a borate, for litter including caffeic acid and a borate, for litter with no treatment, and for litter treated with a borate.

### DETAILED DESCRIPTION OF THE PREFERRED EMBODIMENTS

### I. Definitions

Before describing the present invention in detail, it is to be understood that this invention is not limited to particularly exemplified compositions, systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical manufacturing or formulation process, and may include values that are within 10%, within 5%, within 1%, etc. of a stated value. Furthermore, the terms “substantially”, “similarly”, “about” or “approximately” as used herein represent an amount or state close to the stated amount or state that still performs a desired function or achieves a desired result. For example, the term “substantially” “about” or “approximately” may refer to an amount that is within 10% of, within 5% of, or within 1% of, a stated amount or value.

Some ranges may be disclosed herein. Additional ranges may be defined between any values disclosed herein as being exemplary of a particular parameter. All such ranges are contemplated and within the scope of the present disclosure.

In the application, effective amounts are generally those amounts listed as the ranges or levels of ingredients in the descriptions, which follow hereto. Unless otherwise stated, amounts listed in percentage (“%'s”) are in weight percent (based on 100% active) of the treatment composition.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The phrase ‘free of’ or similar phrases as used herein means that the composition comprises 0% of the stated component, that is, the component has not been intentionally added to the composition. However, it will be appreciated that such components may incidentally form, under some circumstances, as a byproduct or a reaction product from the other components of the composition, or such component may be incidentally present within an included component, e.g., as an incidental contaminant.

The phrase ‘substantially free of’ or similar phrases as used herein means that the composition preferably comprises 0% of the stated component, although it will be appreciated that very small concentrations may possibly be present, e.g., through incidental formation, as a byproduct or a reaction product from the other components of the composition, incidental contamination, or even by intentional addition. Such components may be present, if at all, in amounts of less than 0.25%, less than 0.1%, less than 0.05%, less than 0.01%, less than 0.005%, or less than 0.001%.

For example, in some embodiments of the present litter compositions, no borates may be present, or the compositions may at least be substantially free of borates, as the inclusion of borates has surprisingly been found to not only interfere with the efficacy of some of the present cinnamic and/or rosmarinic compounds, but has been found in such instances to actually decrease inhibition of odor formation to a level that is worse than virgin litter substrate alone. In other words, the combination of the borate and some cinnamic and/or rosmarinic compounds actually promotes formation of ammonia. Such is particularly surprising given that borates are known to improve performance, and the same cinnamic and rosmarinic compounds are shown herein to improve performance, when borates are not present. Stated another way, some combinations of cinnamic and/or rosmarinic compounds with borates have now been shown to be antagonistic to one another, providing results that are worse than virgin litter substrate alone.

In a similar manner, in some embodiments of the present litter compositions, no ethyl cinnamate may be present, or the composition may at least be substantially free of ethyl cinnamate.

### II. Introduction

The present invention is directed to litter compositions including a litter substrate, and one or more cinnamic and/or rosmarinic compounds disposed on or within the litter substrate, which compounds inhibit odor formation. The cinnamic and/or rosmarinic compounds that have been found to inhibit odor formation are not characterized by a strong scent or fragrance. In fact, many of the presently contemplated compounds exhibit no significant scent or fragrance. The terms scent and fragrance are used interchangeably herein.

The litter compositions may include at least one cinnamic or rosmarinic compound such as trans-cinnamic acid, cinnamaldehyde, p-coumaric acid, sinapic acid, caffeic acid, hydrocinnamic acid, rosmarinic acid, ursolic acid, carnosic acid, ferulic acid, and/or combinations thereof. In some embodiments, only a single such compound is included. For example, caffeic acid, or rosmarinic acid, or any other of the above compounds may be the only included cinnamic or rosmarinic compound. A single compound can be effective in inhibiting formation of ammonia (inhibiting odor formation). In addition, testing has shown that at least some combinations of the above compounds exhibit antagonism, such that a combination of two compounds is less effective than either compound alone. For this reason, in some embodiments, only a single cinnamic or rosmarinic compound is included.

### III. Exemplary Litter Compositions

The litter composition comprises a litter substrate. In some embodiments, the litter substrate may be in the form of granules. Although perhaps less typically, other forms may also be possible (e.g., flakes or other shaped particles). The particular material employed as the litter substrate is not particularly limited. For example, any suitable litter substrate known in the art may be used. Exemplary substrate materials include but are not limited to sand, limestone, clay (e.g., bentonite clays), silica gel, diatomaceous earth, shale, gypsum, zeolite, and/or organic materials such as those resulting as byproducts of agricultural or other operations. Such byproducts are typically cellulosic materials, examples of which include, but are not limited to, wood, paper, corn, wheat, tea leaves, walnut shells, grasses and the like.

In an embodiment, the litter substrate may be a clumping substrate, although it will be appreciated that non-clumping litter substrates may also be employed. Sodium bentonite is an example of a clumping litter substrate, which clumps together when wetted so as to form a solid mass separate from the other litter within a litter box. The clumped material can be scooped out and disposed of without requiring replacement of all litter within the litter box. Because of such characteristics, a clumping litter may be bulk replaced much less often than a non-clumping litter. For example, a clumping litter may be entirely replaced in bulk about once a week, about every 2 weeks, or even once a month, as compared to once about every 1-7 days, or every 2-3 days for a non-clumping litter. Substrate materials that themselves may be non-clumping can be coated with, or otherwise provided with sodium bentonite in order to render them clumping. For example, calcium bentonite is typically non-clumping, but can be treated with soda ash (Na₂CO₃), effectively converting at least some of the calcium bentonite in any given granule to sodium bentonite, providing the resulting litter with clumping characteristics.

In some embodiments, the litter substrate may comprise active carbon, which aids in absorption of odors. A fragrance may be included to mask odor, as desired. Additional optional components of the litter substrate will be known to those of skill in the art. Particle sizes for such litter substrates (e.g., in the form of granules) may typically range from about 0.2 mm to about 10 mm, more typically from about 0.3 mm to about 8 mm, and most typically from about 0.5 mm to about 4 mm. A discussion of particle sizes and associated mesh sizes is found in U.S. Pat. No. 9,283,540 and U.S. Publication No. 2013/0177620, and will be apparent to those of skill in the art. Each of the foregoing patent and publication is herein incorporated by reference in its entirety.

At least some of the litter substrate particles are provided with a cinnamic and/or rosmarinic compound disposed on or within the litter substrate (e.g., coated on, impregnated within, or otherwise present on or in the substrate particles). Where the litter substrate comprises a mixture of different types of particles, it will be appreciated that not all of the litter substrate particles need be provided with the cinnamic and/or rosmarinic compound. For example, if a mix of different substrate materials is employed, only one (or some part) of such substrate materials need be provided with the cinnamic and/or rosmarinic compound.

In some embodiments, the cinnamic and/or rosmarinic compound may be applied onto or into the litter substrate in any suitable manner. For example, any technique used to incorporate a borate or fragrance onto or into a litter substrate may be used to incorporate the cinnamic and/or rosmarinic compound into the litter substrate particles. In an embodiment, the cinnamic and/or rosmarinic compound may be provided in a suspension, solution, and/or emulsion, which may then be sprayed or otherwise applied to the litter substrate. Where a fragrance oil is included in the litter composition, the cinnamic and/or rosmarinic compound may be included within an emulsion composition including water, the fragrance oil, the cinnamic and/or rosmarinic compound, and one or more surfactants. Where no fragrance is included in the litter composition (e.g., an unscented litter product), a composition (e.g., a solution or suspension) may be prepared with the cinnamic and/or rosmarinic compound in water or another suitable solvent, which liquid composition may be sprayed or otherwise applied to the litter substrate granules or other particles. Many, if not all of the cinnamic and rosmarinic compounds are soluble in water (e.g., particularly heated water). The desired compound may be solubilized in water or another suitable solvent, and then sprayed or otherwise applied to the litter substrate.

Some embodiments of the present litter compositions may be free, or substantially free of borates. Borates have often been included in litter compositions as borates are known to inhibit the urease enzyme, effectively reducing production and release of ammonia (largely responsible for the malodor of used litter). Eliminating, or at least reducing borate content may be desirable for regulatory reasons, although the present inventor has found an additional reason to specifically exclude borates from within the present litter compositions. In particular, while borates alone are known to inhibit ammonia formation, and while the presently disclosed cinnamic and/or rosmarinic compounds have now been shown by the present inventor to effectively inhibit ammonia formation, the present inventor has discovered antagonism characteristics between some of the present cinnamic and/or rosmarinic compounds and borates. In other words, while borates alone work to inhibit ammonia formation, and while caffeic acid or rosmarinic acid alone work to inhibit ammonia formation, when caffeic acid and a borate are included together, the odor inhibiting characteristics are surprisingly lost. Similar results have been observed for rosmarinic acid and a borate. For this reason, in at least some embodiments, the compositions may be free of borates, or at least substantially free of borates. For example, in some embodiments, no borates may be intentionally added to the litter composition. Any borate concentration may be less than 0.25%, less than 0.1%, less than 0.05%, less than 0.01%, less than 0.005%, or less than 0.001% by weight of the litter composition. In some embodiments, the litter composition may be free of borates (e.g., 0% borate).

Any included fragrance, borates, and/or the cinnamic and/or rosmarinic compound(s) may be incorporated into the litter composition as a nanoemulsion which is sprayed or otherwise applied to the litter substrate, e.g., as described in U.S. Pat. No. 8,495,971, incorporated herein by reference in its entirety. Where such a nanoemulsion is employed, the cinnamic and/or rosmarinic compound may be incorporated into such a nanoemulsion that is sprayed or otherwise applied to the litter substrate.

In other embodiments, e.g., where inclusion of a borate would not be antagonistic relative to the particularly included cinnamic and/or rosmarinic compound, one or more borates may be included. Such a borate may be included as boric acid or a borate salt (e.g., an alkali and/or alkaline earth borate salt). Examples of alkali and or alkaline earth borate salts include, but are not limited to sodium borate, potassium borate, magnesium borate, calcium borate and/or manganese borate. Any borate salt(s) may be present in hydrated form (e.g., Na₂B₄O₇.5H₂O). Any included borate may comprise from about 0.01% to about 5%, from about 0.05% to about 2%, from about 0.1% to about 1%, or from about 0.25% to about 0.5% by weight of the litter composition.

In some embodiments, the litter composition may also be free or substantially free of active carbon, particularly if the inclusion of such active carbon may act to absorb the cinnamic and/or rosmarinic organic compound(s). Where active carbon is included, it may be present in an amount from about 0.01% to about 5%, from about 0.05% to about 2%, from about 0.1% to about 1%, or from about 0.25% to about 0.5% by weight of the litter composition, particularly if no significant absorption of the cinnamic and/or rosmarinic compound that would interfere with inhibition of odor formation occurs.

### IV. Examples

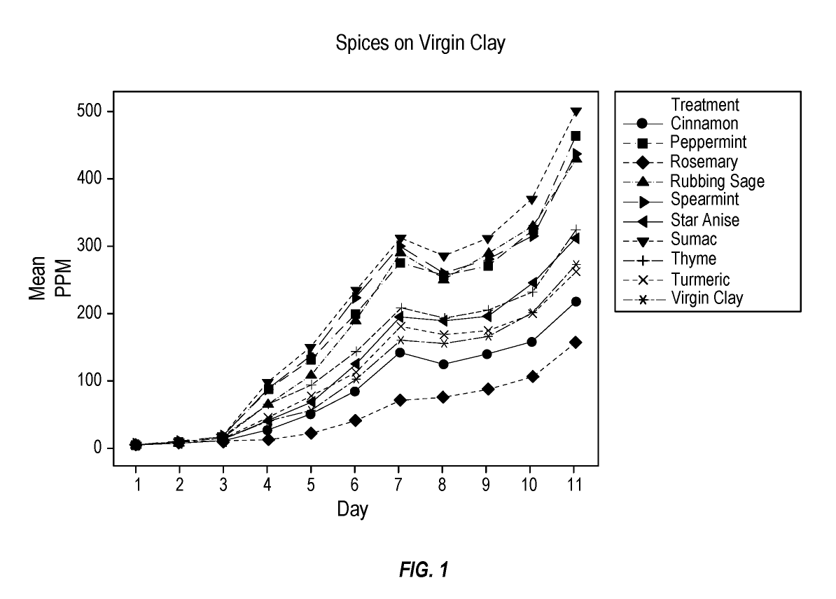

Without limitation, the following actual examples and test results illustrate some exemplary implementations of the present invention. The efficacy of various anti-oxidant rich spices was tested for ability to inhibit ammonia growth in litter compositions. FIG. 1 illustrates the results for each test that was performed. Each litter substrate included sodium bentonite clay. A control included virgin clay, with no added spice. Each of the other samples tested included a particular spice, dosed onto or into the clay litter substrate at 1.5 g per 100 g of clay substrate (a 1.5% loading of each of the tested spices). The tested spices were cinnamon, peppermint, rosemary, rubbing sage, spearmint, star anise, sumac, thyme, and turmeric. A control was also tested that included no spice at all. Each sample was contacted with 20 mL of feline urine, and then monitored over a period of 11 days, with the mean PPM of ammonia recorded for each day. The results are presented in FIG. 1.

As shown in FIG. 1, the virgin clay control sample (with no spice treatment) actually performed significantly better than those samples treated with sumac, peppermint, spearmint, rubbing sage, thyme, and star anise. In other words, the foregoing spices were actually found to promote, rather than inhibit ammonia formation. The sample treated with turmeric performed similarly to the control sample (i.e., turmeric did not inhibit nor significantly promote ammonia formation). The samples treated with cinnamon and with rosemary showed levels of ammonia that were significantly lower than the control, so that these spices showed inhibition of ammonia formation.

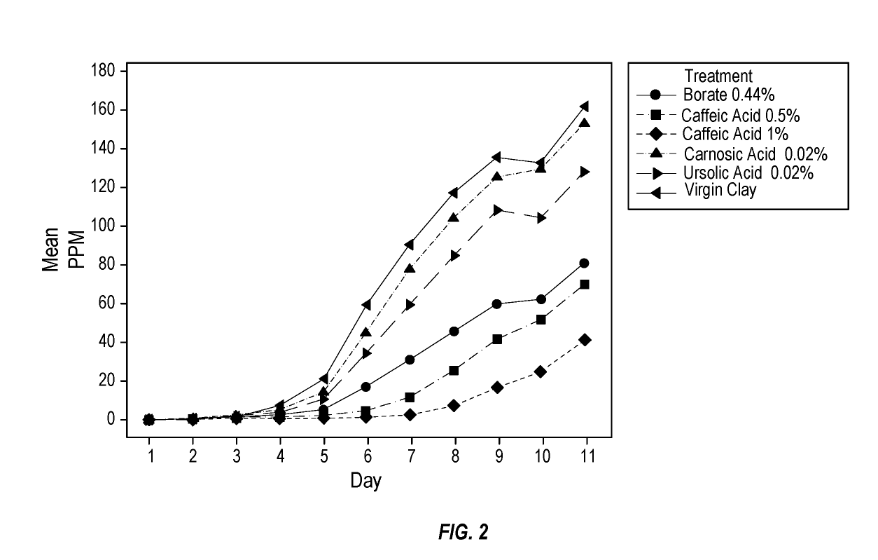

Based on the above results, further tests were performed to determine the effect of individual cinnamic compounds (i.e., compounds present in cinnamon) and rosmarinic compounds (i.e., compounds present in rosemary) on ammonia formation in litter. Results were compared with borate treated litter for comparison. FIG. 2 shows test results for testing similar to that represented in FIG. 1, but for various specific cinnamic and/or rosmarinic compounds, at various dosing levels, and as compared to borate treated litter and as compared to virgin clay (no treatment). The results in FIG. 2 show that even a very small dosing of carnosic and/or ursolic acid (e.g., 0.02 g per 100 g of litter, or 0.02% by weight) provides significant inhibition of ammonia formation in the litter treated therewith. Higher dosages of caffeic acid (0.5 g per 100 g of litter, or 0.5% by weight, and 1 g per 100 g of litter, or 1%) show excellent inhibition of ammonia formation over the 11 day test period. The results for the 1% caffeic acid treatment show less than 40 ppm of ammonia at day 11, well below the OSHA threshold limit of 50 ppm. The result for the 0.5% caffeic acid treated litter shows less than 60 ppm of ammonia at day 11, which is comparable to, and even somewhat below the 76 ppm of ammonia at day 11 for the same litter substrate treated with 0.44% borate. FIG. 2 thus shows that caffeic acid is comparable to, and even slightly better at inhibiting ammonia formation than is the borate, where comparable amounts of each are included. Caffeic acid is thus an excellent choice for substitution of borate for inhibiting odor formation.

FIG. 2 further shows how a wide range of amounts of the various compounds (e.g., from 0.02% up to 1% by weight of the litter composition) may be effective in inhibiting odor formation. FIG. 2 shows how as little as 0.02% (or presumably as little as 0.01%) is effective in providing some odor inhibition effect. FIG. 2 further shows how with increasing concentration, the included cinnamic and/or rosmarinic compound provides even greater inhibition of odor formation (e.g., at 0.5%, and 1%). Even greater inhibition would be expected at 1.5%, 2%, 2.5%, 3%, 3.5%, 4%, 4.5%, and 5% loading.

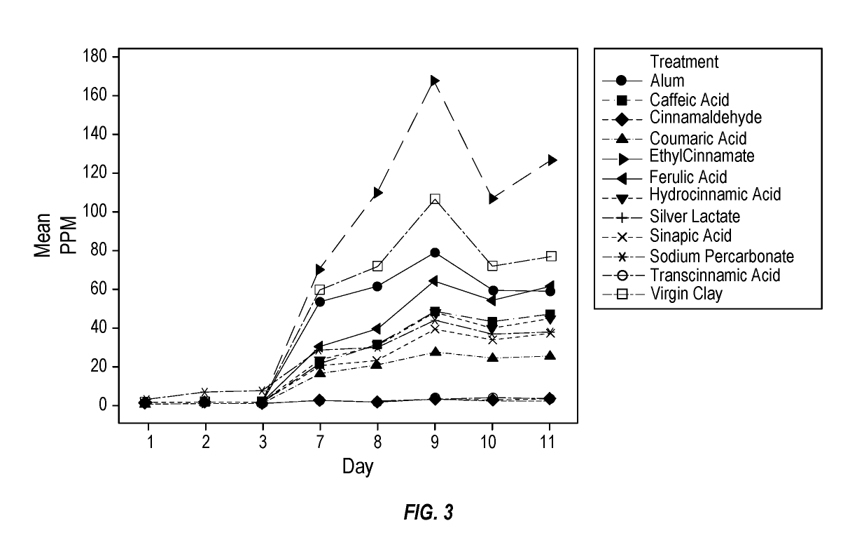

FIG. 3 shows results for various litter compositions treated with additional cinnamic compounds, as well as comparisons for litter treated with alum (e.g., hydrated potassium aluminum sulfate), litter treated with silver lactate, litter treated with sodium percarbonate (2 Na₂CO₃.3 H₂O₂), and virgin clay litter with no treatment. Each of the charted results are better than the virgin clay litter control, except the litter treated with ethyl cinnamate. Although ethyl cinnamate is structurally similar to the presently described cinnamic compounds which inhibit odor formation, ethyl cinnamate actually promotes ammonia (odor) formation, for reasons not entirely understood. If one wished to promote ammonia formation, ethyl cinnamate would be an excellent choice. In the litter compositions where ammonia formation is undesirable, ethyl cinnamate may thus be specifically excluded from such litter compositions. The litter compositions may thus be free, or at least substantially free, of ethyl cinnamate. For example, the litter composition may include no more than 0.1% ethyl cinnamate, no more than 0.05% ethyl cinnamate, no more than 0.01% ethyl cinnamate, no more than 0.005% ethyl cinnamate, no more than 0.001% ethyl cinnamate, or 0% ethyl cinnamate. Each of the treatments tested in FIG. 3 were dosed at 0.5 g per 100 g of litter. Many of the other treatments tested were similarly dosed, unless stated otherwise (i.e., 0.5 g per 100 g of litter).

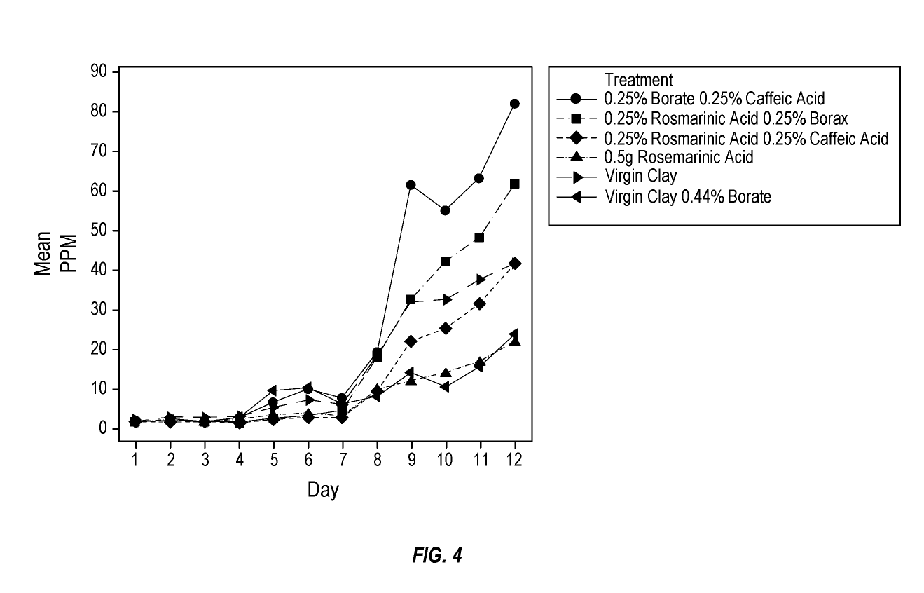

As shown in FIG. 4, some combinations of the present cinnamic and/or rosmarinic compounds were tested, as well as testing combinations of a cinnamic/rosmarnic compound with a borate in the same litter composition. The results are compared in FIG. 4 with virgin clay (no treatment), and with clay treated with 0.44% borate. FIG. 4 also shows results for a litter composition including 0.5% rosmarinic acid on or within the litter substrate granules, which was comparable in efficacy to the borate treated litter substrate. It is surprising to note, as shown in FIG. 4, that while rosmarinic acid or caffeic acid alone are quite effective at inhibiting odor formation, when either is combined with borate, the combination actually acts to promote, rather than inhibit ammonia formation. In other words, the charted results for the combination of borate and caffeic acid, and for borate and rosmarinic acid are higher in ammonia concentration at day 12 than for the virgin clay control. Such a result is very surprising, as either alone is quite effective.

Also surprising, FIG. 4 shows antagonism between rosmarinic acid and caffeic acid, where a combination of the two are included (e.g., 0.25% of each). The results show the combination provides some inhibition of odor formation up to day 11, and that by day 12, there is no significant difference between the combination and the virgin clay control. Thus, in at least some embodiments, the litter composition may include rosmarinic acid, or caffeic acid, but not the combination of the two. By extension, some embodiments of the present litter compositions may include only a single cinnamic or rosmarinic compound, rather than combinations of two or more such compounds.

The results shown in FIG. 3, and that of rosmarinic acid shown in FIG. 4, are tabulated below in Table 1, showing the mean day 11 ammonia PPM level.

TABLE 1

| | Day 11 |
|---|---|
| Example Compound | NH₃ PPM |
| Trans-cinnamic acid | 4.493 |
| Cinnamaldehyde | 4.150 |
| p-coumaric acid | 26.199 |
| Sinapic acid | 38.428 |
| Caffeic acid | 47.894 |
| Hydrocinnamic acid | 45.720 |
| Ferulic acid | 62.182 |
| Ethyl cinnamate | 126.324 |
| Rosmarinic acid | 20-30 |
| Untreated Virgin Clay Control | 76.652 |

The chemical structures of each of the above compounds are as follows.

Trans-Cinnamic Acid:

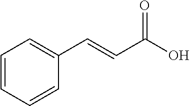 [SMILES: O=C(O)/C=C/c1ccccc1]

Cinnamaldehyde:

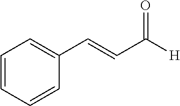

p-Coumaric Acid:

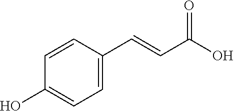 [SMILES: O=C(O)/C=C/c1ccc(O)cc1]

Sinapic Acid:

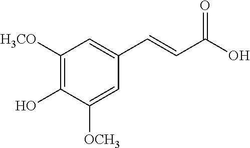 [SMILES: COc1cc(/C=C/C(=O)O)cc(OC)c1O]

Caffeic Acid:

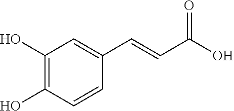 [SMILES: O=C(O)/C=C/c1ccc(O)c(O)c1]

Hydroxycinnamic Acid:

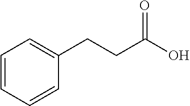 [SMILES: O=C(O)CCc1ccccc1]

Ferulic Acid:

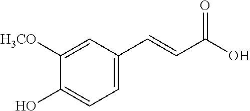 [SMILES: COc1cc(/C=C/C(=O)O)ccc1O]

Ethyl Cinnamate:

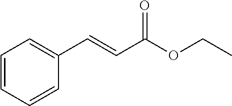

Rosmarinic Acid:

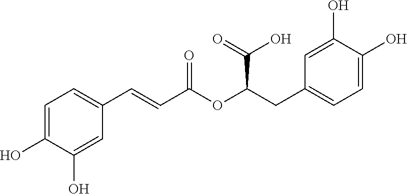 [SMILES: O=C(/C=C/c1ccc(O)c(O)c1)O[C@H](Cc1ccc(O)c(O)c1)C(=O)O]

Ursolic Acid:

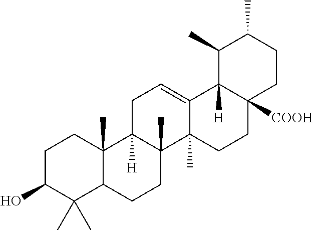

Carnosic Acid:

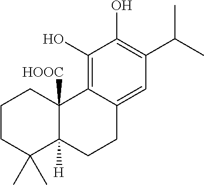 [SMILES: CC(C)c1cc2c(c(O)c1O)[C@@]1(C(=O)O)CCCC(C)(C)[C@@H]1CC2]

While ursolic acid and carnosic acid differ structurally from the other listed compounds, and may perhaps not technically be compounds included within cinnamon or rosemary, they are classified herein as cinnamic and/or rosmarinic compounds for simplicity, as they are polyphenols that have now been shown to exhibit an ability to inhibit ammonia (odor) formation in litter compositions provided therewith.

It will be appreciated from the above structures that rosmarinic acid is similar to caffeic acid, with the rosmarinic acid including essentially two of the caffeic acid molecules joined together as an ether. Although not entirely understood why ethyl cinnamate promotes, rather than inhibits odor formation, it is noted that ethyl cinnamate includes a terminal ethyl group, while none of the other structures which work to inhibit odor formation include a similar terminal ethyl group. Carnosic acid includes a terminal isopropyl group, and terminal methyl groups, but is effective in inhibiting odor formation. Urisolic acid includes terminal methyl groups, but is also effective in inhibiting odor formation.

It is noted that the above effective compounds do not include nitrogen groups (e.g., amines, cyanides, hydroxylamines, or other nitrogen-containing groups) therein (e.g., as opposed to cinnamic acid nitriles). Nor are any of the effective compounds alcohols. There are included carboxylic acids, and aldehydes, but no organic alcohols (e.g., cinnamic alcohols). It will be apparent that any of the above described compounds (e.g., cinnamic acid nitriles, cinnamic alcohols, etc.), or classes of compounds may be specifically excluded from the present litter compositions.

One will appreciate in light of the disclosure herein that the present invention may be embodied in other specific forms without departing from its spirit or essential characteristics. Thus, the described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A litter composition, comprising:
a litter substrate; and
a cinnamic or rosmarinic compound exhibiting no significant scent or fragrance, disposed on or within the litter substrate, the cinnamic or rosmarinic compound comprising only one of trans-cinnamic acid, cinnamaldehyde, p-coumaric acid, sinapic acid, caffeic acid, hydrocinnamic acid, rosmarinic acid, ursolic acid, or carnosic acid;
wherein the cinnamic or rosmarinic compound comprises from 0.1% to 5% by weight of the litter composition;
wherein the litter composition is substantially free of ethyl cinnamate;
the litter composition exhibiting an ammonia level of no more than 50 ppm at 11 days after dosing the litter composition with 20 mL of feline urine.

2. The composition of claim 1, wherein the cinnamic or rosmarinic compound comprises a hydroxycinnamic acid selected from caffeic acid, sinapic acid, rosmarinic acid, hydrocinnamic acid, or p-coumaric acid.

3. The composition of claim 1, wherein the cinnamic or rosmarinic compound comprises caffeic acid or rosmarinic acid, but not a combination thereof.

4. The composition of claim 1, wherein the cinnamic or rosmarinic compound comprises ursolic acid or carnosic acid.

5. The composition of claim 1, wherein the litter substrate is in the form of granules.

6. The composition of claim 1, wherein the litter substrate comprises a bentonite clay.

7. The composition of claim 6, wherein the bentonite clay comprises sodium bentonite.

8. The composition of claim 6, wherein the bentonite clay comprises calcium bentonite which has been treated with soda ash such that at least some of the calcium bentonite has been converted to sodium bentonite.

9. The composition of claim 1, wherein the litter composition further comprises a borate.

10. The composition of claim 9, wherein the borate comprises at least one of boric acid or a borate salt.

11. The composition of claim 9, wherein the borate comprises one or more of sodium borate, potassium borate, magnesium borate, calcium borate, manganese borate, or a combination thereof.

12. The composition of claim 1, wherein the litter composition is substantially free of borates.

13. The composition of claim 1, wherein the litter substrate is a cellulosic organic substrate comprising one or more of wood, paper, corn, wheat, tea leaves, walnut shells, grasses, or a combination thereof.

14. The composition of claim 1, wherein the litter substrate comprises diatomaceous earth, shale, gypsum, zeolite, sand, limestone, silica gel, or a combination thereof.

15. (canceled)

16. The composition of claim 1, wherein the litter substrate comprises active carbon.

17. A litter composition, comprising:
a litter substrate comprising a bentonite clay; and
a cinnamic or rosmarinic compound exhibiting no significant scent or fragrance, disposed on or within the litter substrate, the cinnamic or rosmarinic compound comprising only one of trans-cinnamic acid, cinnamaldehyde, p-coumaric acid, sinapic acid, hydrocinnamic acid, rosmarinic acid, or ursolic acid;
wherein the cinnamic or rosmarinic compound comprises from 0.1% to about 1% by weight of the litter composition;
wherein the litter composition is substantially free of ethyl cinnamate and borates;
the litter composition exhibiting an ammonia level of no more than 50 ppm at 11 days after dosing the litter composition with 20 mL of feline urine.

18. (canceled)

19. A litter composition, comprising:
a litter substrate in the form of granules, the litter substrate comprising a bentonite clay; and
a cinnamic or rosmarinic compound exhibiting no significant scent or fragrance, disposed on or within the litter substrate, the cinnamic or rosmarinic compound comprising only one of trans-cinnamic acid, cinnamaldehyde, p-coumaric acid, or rosmarinic acid;
wherein the cinnamic or rosmarinic compound comprises from 0.1% to about 1% by weight of the litter composition;
wherein the litter composition is substantially free of ethyl cinnamate and is free of borates;
the litter composition exhibiting an ammonia level of no more than 30 ppm at 11 days after dosing the litter composition with 20 mL of feline urine.

20. (canceled)

21. The composition of claim 19, wherein the cinnamic or rosmarinic compound comprises from about 0.25% to about 0.5% by weight of the litter composition.

22. The composition of claim 17, wherein the cinnamic or rosmarinic compound comprises from about 0.25% to about 0.5% by weight of the litter composition.

23. The composition of claim 1, wherein the cinnamic or rosmarinic compound comprises from about 0.25% to about 0.5% by weight of the litter composition.
